(19) United States
(12) Patent Application Publication
(10) Pub. No.: US 2006/0210905 A1
(43) Pub. Date: Sep. 21, 2006

(54) Carrier for developer developing electrostatic image, developer including the carrier, and image forming method and process cartridge using the developer

(76) Inventors: Naoki Imahashi, Mishima-shi (JP); Kimitoshi Yamaguchi, Numazu-shi (JP); Masashi Nagayama, Numazu-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/373,109

(22) Filed: Mar. 13, 2006

(30) Foreign Application Priority Data
Jul. 13, 2005 (JP) 2005-203853
Mar. 16, 2005 (JP) 2005-075962

(51) Int. Cl. G03G 9/113

(52) U.S. Cl. 430/111.35; 430/125

(57) ABSTRACT

A carrier including a magnetic core material; and a resin layer located on the core material, wherein the carrier has a weight average particle diameter (Dw) of from 22 μm to 32 μm, a ratio Dw/Dp of greater than 1.0 and less than 1.2, wherein Dp represents a number average particle diameter of the carrier, and includes carrier particles having a particle diameter of less than 20 μm in an amount of 0 to 7% by weight, and carrier particles having a particle diameter of less than 36 μm in the carrier in an amount of 90 to 100% by weight, and the core material has a volume resistivity log (R1) of from 8.0 to 10.5 in an electric field of 50 V/mm and a ratio log (R2)/log (R3) of from 0.85 to 1.0, wherein R2 and R3 represent volume resistivities of chains of particles of the core material in electric fields of 250 V/mm and 50 V/mm, respectively.

### BACKGROUND OF THE INVENTION

1. Field of the Invention

The present invention relates to a carrier for use in a developer for developing an electrostatic image. In addition, the present invention relates to a developer for developing an electrostatic image. Further, the present invention relates to an image forming method and a process cartridge using a developer.

2. Discussion of the Background

Developing methods for developing an electrostatic image are broadly classified into one-component developing methods, which use a one-component developer including a toner as a main component, and two-component developing methods, which use a two-component developer including a carrier such as glass beads and magnetic materials (whose surface may be coated with a resin or the like material), and a toner as main components.

Since the two-component developing methods use a carrier, the toner therein can be friction-charged by the surface of the carrier which has a large area. Therefore, the toner has better and more stable charge properties than a toner in a one-component developer. Accordingly, the two-component developing methods can typically produce high quality images for a long period of time. In addition, since the two-component developing methods have an advantage in that a large amount of toner can be supplied to a developing region, the developing methods are typically used for high speed image forming apparatuses.

Because of having the above-mentioned advantages, the two-component developing methods are typically used for recent digital electrophotographic image forming apparatuses in which an electrostatic image formed on a photoreceptor using a laser beam is developed with a developer.

Recently, in order to improve image qualities such as resolution, reproducibility of high-lighted portions and color images, and granularity (i.e., microscopic evenness), the size of electrostatic dots serving as minimum units of electrostatic images is reduced while the density of dots is increased. Therefore, a need exist for a developing method by which such high density dot images constituted of small dots can be faithfully developed. In attempting to fulfill the need, various proposals concerning process conditions and developer conditions (such as toners and developers) have been made.

For example, techniques in that the developing gap formed between an electrostatic image bearing member and a developing roller is narrowed; the photosensitive layer of an image bearing member is thinned; and the diameter of the laser light beam used for forming electrostatic images on an image bearing member is decreased have been proposed. However, the techniques have drawbacks such that the manufacturing costs of the apparatus increases, and the apparatus has poor reliability.

On the other hand, toners and carriers having a small particle diameter have been proposed to fulfill the need mentioned above.

Specifically, published unexamined Japanese patent application No. (hereinafter referred to as JP-A) 58-144839 discloses a carrier including a particulate ferrite which has a spinel structure and which has an average particle diameter of less than 30 μm. This carrier is not coated with a resin and is used only for low development electric field conditions. This carrier has such drawbacks as to have low developing ability and short life (because a resin is not coated thereon).

Japanese patent No. 3,029,180 (i.e., JP-A 07-98521) discloses a carrier which has a 50% average particle diameter (D₅₀) of from 15 to 45 μm, and includes particles having a particle diameter of less than 22 μm, less than 16 μm, greater than 62 μm, and greater than 88 μm, in an amount of from 1 to 20%, not greater than 3%, from 2 to 15% and not greater than 2%, respectively, wherein the carrier satisfies the following relationship:
1.2≦S1/S2≦2.0,
wherein S1 represents the specific surface area of the carrier, which is determined by an air permeability method; and S2 is represented by the following equation:
S2=(6/ρ*D₅₀)×10⁴
wherein ρ represents the specific gravity of the carrier.

To use a carrier having a relatively small particle diameter has the following advantages:

(1) Since such a small carrier has a larger surface area per unit volume than normal carriers, a sufficient amount of charge can be imparted to each of toner particles. Therefore, the resultant developer hardly includes toner particles having low charge quantity or a reverse-polarity charge. Accordingly, the developer hardly cause a background development problem in that the background area of an image is soiled with toner particles; a toner scattering problem in that toner particles are scattered around a dot image; and a blurring image problem in that a blurring image is formed. Therefore, images having good resolution can be produced.

(2) Since such a small carrier has a larger surface area per unit volume than normal carriers and therefore the background development problem is hardly caused, images with high image density can be produced even when the average charge quantity of the toner is decreased. In other words, such a small carrier can remedy the drawback of a toner with a small particle diameter. Namely, by using a combination of a small carrier and a small toner, high quality images can be produced.

(3) Since such a small carrier can form a dense magnetic brush, which has good fluidity, the resultant images hardly have a trace of the magnetic brush (such as scratched images).

However, small carriers have a drawback in that carrier particles are easily attracted to electrostatic images (hereinafter this problem is sometimes referred to as a carrier adhesion problem), resulting in transferring of the carrier particles to an image bearing member, thereby damaging the image bearing member. In addition, the carrier particles in the toner image transferred on a receiving material damages a fixing roller. Therefore, it is hard to use such a small carrier for an electrophotographic developer at the present time.

Particularly, when the weight average particle diameter is less than 30 μm, the granularity (i.e., microscopic evenness) of images can be dramatically improved, and thereby high quality images can be produced. However, carriers having such a small particle diameter easily cause the carrier adhesion problem. Therefore, it is hard to produce high quality images for a long period of time using such a small carrier.

Specifically, when the following relationship is satisfied, a carrier particle or a carrier particle chain is adhered to an electrostatic image:
Fm<Fc
wherein Fm represents a magnetic binding force of a magnet or the like to hold the carrier particle; and Fc represents a force of an electrostatic image or the like to attract the carrier.

In this regard, Fm is represented as follows:
Fm=k×Mc×G
wherein Mc represents the magnetic moment of the carrier and G represents the magnetic gradient of the magnetic binding force.

The magnetic moment Mc is further represented by the following equation:
Mc=W×M=( 4/3)π·r³·ρ×M
wherein W represents the weight of the carrier particle; M represents the magnetization of the carrier particle; r represents the radius of the carrier particle; and p represents the true specific gravity of the carrier particle.

Since the magnetic moment is proportional to r³, the magnetic moment rapidly decreases as the radius of the carrier particle deceases. The attraction force Fc changes depending on the developing potential, background potential, centrifugal force applied to the carrier particle, resistance of the carrier particle, and the charge quantity of the developer. Therefore, in order to prevent occurrence of the carrier adhesion problem, it is preferable to control such factors so that the attraction force Fc decreases. However, since these factors are closely related to developing ability of the carrier and image qualities such as background development and toner scattering, it is difficult to drastically change the level of the factors.

Because of these reasons, a need exists for a carrier which hardly causes the carrier adhesion problem even after long repeated use and which can maintain good charge imparting ability even when the environmental conditions are changed and/or the developer is preserved for a long period of time.

### SUMMARY OF THE INVENTION

As an aspect of the present invention, a carrier is provided which includes:

a magnetic core material; and

a layer located on the surface of the core material and including a resin,

wherein the carrier satisfies the following relationships (1)-(6):

(1) 22 μm≦Dw≦32 μm, wherein Dw represents the weight average particle diameter of the carrier;

(2) 1.0<Dw/Dp<1.2, wherein Dp represents the number average particle diameter of the carrier;

(3) 0% by weight≦C_{<20}≦7% by weight, wherein C_{<20} represents the content of carrier particles having a particle diameter of less than 20 μm;

(4) 90% by weight≦C_{<36}≦100% by weight, wherein C_{<36} represents the content of carrier particles having a particle diameter of less than 36 μm;

(5) 8.0≦log (R1)≦10.5, wherein R1 represents the volume resistivity (in units of Ω·cm) of the core material, which is determined in an electric field of 50 V/mm; and

(6) 0.85≦log (R2)/log (R3)≦1.0, wherein R2 represents the volume resistivity (in units of Ω·cm) of chains of particles of the core material, which is determined in an electric field of 250 V/mm, and R3 represents the volume resistivity (in units of Ω·cm) of the chains of particles of the core material, which is determined in an electric field of 50 V/mm, wherein the chains of particles of the core material are formed using a magnetic pole with 1500 gauss.

As another aspect of the present invention, a developer is provided which includes the carrier mentioned above and a toner.

As yet another aspect of the present invention, an image forming method is provided which includes:

developing an electrostatic image on an image bearing member with the developer mentioned above to form a toner image on the image bearing member;

transferring the toner image to a receiving material; and

cleaning a surface of the image bearing member after the image transfer process.

As a further aspect of the present invention, a process cartridge is provided which includes:

an image bearing member configured to bear an electrostatic image thereon; and

a developing device configured to develop the electrostatic image with the developer mentioned above to form a toner image on the image bearing member,

wherein the image bearing member and the developing device are unitized in the process cartridge.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

FIG. 1 is a schematic view illustrating an instrument for measuring the volume resistivity (R1) of a core material;

FIG. 2 is a schematic view illustrating an instrument for measuring the volume resistivities (R2 and R3) of chains of particles of a core material, which are formed in a magnetic field;

FIG. 3 is a schematic view illustrating an image forming apparatus for use in the image forming method of the present invention;

FIG. 4 is a schematic view illustrating another image forming apparatus for use in the image forming method of the present invention, which includes plural developing devices;

FIG. 5 is a schematic view illustrating another image forming apparatus for use in the image forming method of the present invention, which includes four image bearing members and respective developing devices; and

FIG. 6 is a schematic view illustrating an embodiment of the process cartridge of the present invention.

### DETAILED DESCRIPTION OF THE INVENTION

The carrier of the present invention includes a particulate magnetic core material and a layer located on a surface of the particulate magnetic core material and including a resin (hereinafter this layer is sometimes referred to as a resin layer).

The carrier has a weight average particle diameter (Dw) of from 22 to 32 μm, and more preferably from 23 to 30 μm. When the weight average particle diameter (Dw) is too large, the diameter of dot toner images varies, resulting in deterioration of dot reproducibility and granularity of the resultant images although occurrence of the carrier adhesion problem can be certainly prevented. In addition, the background development problem tends to be caused if the toner concentration in the developer is increased. In this regard, the carrier adhesion problem means a problem in that carrier particles are adhered to an image portion and/or a background portion of an image. When the electric field intensity at the image portion or the background portion increase, the amount of the carrier particles adhered to the image portion and the background portion increases. Since the electric field strength at an image portion is decreased after the image portion is developed with a developer, the probability of the carrier adhesion problem in an image portion is less than that in a background portion. Occurrence of the carrier adhesion problem is not preferable because the image bearing member such as photoreceptors, and the fixing rollers are damaged by the carrier particles.

The content of particles having a particle diameter of less than 20 μm in the carrier of the present invention is not greater than 7% by weight, preferably not greater than 5% by weight, and more preferably not greater than 3% by weight. When the content is too high, a large amount of carrier particles having a small magnetic moment are present in the magnetic brush, and thereby the carrier adhesion problem is easily caused.

The content of such small carrier particles is preferably as low as possible. However, in order to reduce the content as low as possible, many classification operations have to be performed, and therefore the manufacturing costs increase. Therefore, the lower limit of the content of such small particles is about 0.5% by weight in view of the manufacturing cost.

It is preferable that the core material of the carrier of the present invention has a weight average particle diameter of from 22 to 32 μm, and a sharp particle diameter distribution such that particles having a particle diameter of less than 36 μm are included therein in an amount of not less than 90% by weight, and more preferably not less than 92% by weight. By coating a resin on the surface of such a core material, a carrier which has a sharp magnetic moment distribution such that occurrence of the carrier adhesion problem can be prevented can be produced.

In the present application, the weight average particle diameter (Dw) of the carrier, core material and toner is determined based on the particle diameter distribution thereof on a number basis (i.e., graph illustrating the relationship between a particle diameter range and the number of particles having the diameter range). Specifically, the weight average particle diameter (Dw) is represented by the following equation.
Dw={1/Σ(nD³)}×{(nD⁴)}
wherein D represents the particle diameter representing each particle diameter channel (i.e., each particle diameter range); and n represents the total number of the particles having a diameter within the particle diameter channel.

In this regard, the channel means as follows. When a particle diameter distribution of a particulate material is measured, the particle diameter range to be measured is divided into several small particle diameter ranges, and the number of particles having a diameter within each of the small particle diameter ranges is counted. The channel means the small particle diameter range, and has a width of 2 μm in the particle diameter measuring method used for the present application. The lowest particle diameter of each channel is defined as the particle diameter representing the channel.

In the present application, the weight average particle diameter and particle diameter distribution are determined using an instrument, MICROTRACK PARTICLE ANALYZER (MODEL HRA9320-X100 from Honeywell, Inc.).

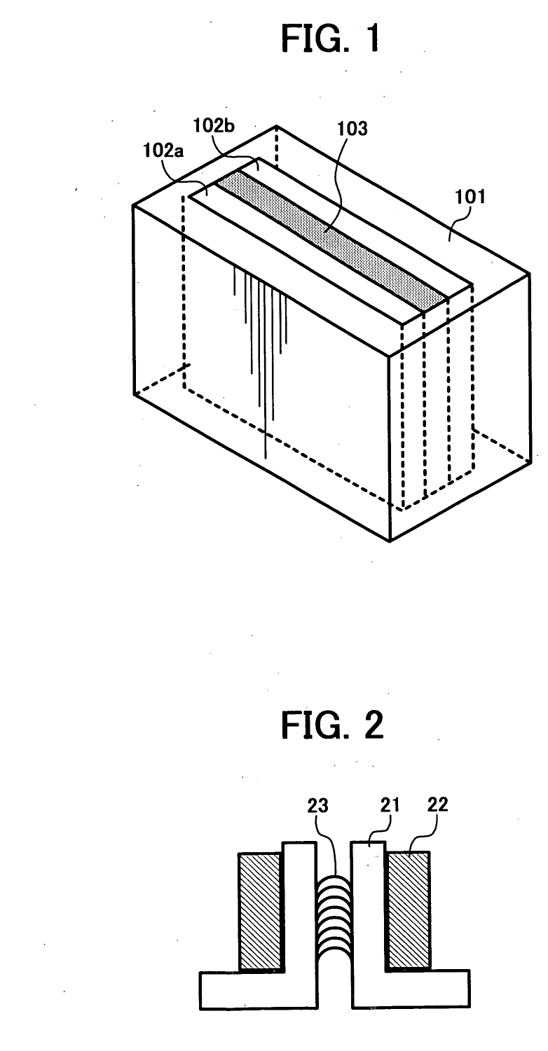

In the present application, the volume resistivity R1 (Ω·cm) of a core material in an electric field of 50V/mm is determined by the following method. The method will be explained referring to FIG. 1.

A core material 103 is contained in a cell 101 illustrated in FIG. 1, which is made of a fluorine-containing resin and which has electrodes 102a and 102b, wherein each of the electrodes 102a and 102b has a dimension of 2 cm×4 cm and the distance between the electrodes 102a and 102b is 2 mm. A DC voltage of 100V is applied between the electrodes 102a and 102b, and the resistance (Ω) of the core material is measured with an instrument, HIGH RESISTANCE METER 4329A (4329A+LJK 5HVLVWDQFH OHWHU from Yokogawa Analytical Systems, Inc.). Then the volume resistivity R1 (Ω·cm) of the core material is calculated from the resistance.

When a core material is fed into the cell, at first the core material is fed into the cell so as to overflow from the cell. Then a nonmagnetic flat blade is slid once along the upper surface of the cell to remove the portion of the core material projected from the cell.

In the present application, the volume resistivities R2 and R3 of a core material in a magnetic field are determined by the following method. The method will be explained referring to FIG. 2.

A pair of parallel electrodes 21 are set so as to form a gap of 2 mm. Then a magnetic pole 22 having a surface magnetic flux density of 1500 Gauss is set on the backside of each electrode 21. Then 200 mg of a core material is fed into the gap to form particle chains of the core material therein. A DC voltage of 500V or 100V is applied between the electrodes 21 to measure the resistance of the particle chains. Then the volume resistivities R2 and R3 (≠·cm) of the core material in an electric field of 250 V/mm and 50 V/mm, respectively, are calculated from the resistances (Ω).

The volume resistivity in a logarithm scale (log (R1)) of the core material of the carrier of the present invention is preferably from 8.0 to 10.5, and more preferably from 8.5 to 10.0. In addition, the ratio (log (R2)/log (R3)) is preferably from 0.85 to 1.0. When the core material satisfies these conditions, the carrier hardly causes the carrier adhesion problem even after long repeated use.

The reason why the carrier adhesion problem is easily caused after long repeated use is not yet determined, but is considered to be as follows.

When a carrier having a resin layer thereon is repeatedly used for image developing, the resin layer is abraded and thereby the resin layer has defective portions (for example, a portion of the resin layer is lost). In a two component developing method, a developer develops an electrostatic image while forming a magnetic brush, and a high electric field is applied to the particle chains of the magnetic brush. When the resin layer of the carrier has defective portions, a large current is flown through the defective portions, resulting in occurrence of the carrier adhesion problem if the core material has volume resistivities outside the above-mentioned ranges.

The core material of the carrier of the present invention is typically prepared by classifying a pulverized magnetic material into several particle groups having different particle diameter distributions. When ferrite and magnetite are used for the core material, at first a granulated ferrite or magnetite is classified, followed by sintering. Then the sintered material is classified into several particle groups as mentioned above. It is preferable that two or more of the thus prepared several particle groups are mixed to prepare the core material of the carrier of the present invention.

When the above-mentioned classification operation is performed, known classifying machines such as sieves, gravity classifying machines, centrifugal classifying machines and inertial classifying machines can be used. Among these classifying machines, air classifying machines such as gravity classifying machines, centrifugal classifying machines and inertial classifying machines are preferably used.

The present inventors made an experiment in which several carriers having different magnetizations (M) are prepared to change the magnetic binding force Fm. As a result of the experiment, it is found that the magnetic moment of the core material in a magnetic field of 1000 Oe is preferably not less than 50 emu/g and more preferably not less than 70 emu/g, to prevent occurrence of the carrier adhesion problem. The upper limit of the magnetic moment of the core material is not particularly limited, but is generally about 150 emu/g. In the present application, the magnetic moment is measured by the following method.

A B-H tracer (BHU-60 from Riken Denshi Co., Ltd.) is used for measuring the magnetic moment. At first, 1 gram of a core material is contained in a cylindrical cell and the cell is set in the B-H tracer. A magnetic field applied to the core material is gradually increased from 0 to 3000 Oe. Then the magnetic field is gradually decreased from 3000 to 0 Oe. In addition, a reverse magnetic field is applied to the core material while gradually increased from 0 to 3000 Oe, and then the reverse magnetic field is decreased from 3000 to 0 Oe. Further, the first-mentioned magnetic field is applied again to the core material while gradually increased from 0 to 3000 Oe to obtain a B-H curve of the core material. The magnetic moment of the core material is determined from the B-H curve.

Specific examples of the materials for use as the core material of the carrier of the present invention, which have a magnetic moment of not less than 50 emu/g in a magnetic field of 1000 Oe, include ferromagnetic materials such as iron and cobalt; magnetite; hematite; ferrites such as Li ferrite, Mn—Zn ferrite, Cu—Zn ferrite, Ni—Zn ferrite, Ba ferrite and Mn ferrite; etc.

Ferrites mean materials having the following formula.
(MO)_{X}(NO)_{Y}(Fe₂O₃)_{Z}
wherein X+Y+Z=100% by mole; and M and N independently represent a metal atom such as Ni, Cu, Zn, Li, Mg, Mn, Sr, and Ca.

Namely, ferrites are perfect mixtures of a metal (II) oxide and ferric (III) oxide.

Specific examples of the materials for use as the core material of the carrier of the present invention, which have a magnetic moment of not less than 70 emu/g in a magnetic field of 1000 Oe, include iron, magnetite, Mn—Mg—Sr ferrite, Mn ferrite, etc.

The bulk density of the carrier is preferably not less than 2.1 g/cm³, and more preferably not less than 2.35 g/cm³, to prevent occurrence of the carrier adhesion problem. In general, core materials having a low bulk density are porous or have a rough surface. These core materials tend to easily cause the carrier adhesion problem.

When the bulk density of the carrier is too low, the magnetic moment of one particle of the carrier is small, and thereby the carrier adhesion problem is easily caused.

In addition, when the core material has a rough surface, the thickness of the resin layer formed thereon varies, resulting in variation of the charge quantity and resistivity of the carrier. Therefore, the durability of the carrier deteriorates after long repeated use and in addition the carrier adhesion problem is easily caused.

In order to increase the bulk density of a core material, it is possible to sinter the core material at a high temperature. However, a problem in that particles are fused with each other so as not to be easily released from each other occurs. Therefore, when ferrites or the like materials (which typically have a true specific gravity of not greater than 5) are used as core materials, the upper limit of the bulk density of the carrier is preferably 2.6 g/cm³, and more preferably 2.5 g/cm³. When iron (which has a true specific gravity of 7.8) and magnetites (which have a true specific gravity of 5.2) are used as core materials, the upper limit of the bulk density of the carrier is slightly higher than that of ferrites.

In the present application, the bulk density of a carrier is determined by the following method which is based on the metal powder's apparent density testing method described in JIS Z-2504).

(1) At first, a carrier is allowed to naturally fall into a cylindrical container, which is made of stainless steel and has a volume of 25 cm³, through an orifice having a diameter of 2.5 mm;

(2) a nonmagnetic flat blade is slid once along the upper surface of the cylindrical container to remove the portion of the carrier projected from the container;

(3) the weight of the carrier in the container is measured to determine the bulk density (g/cm³) of the carrier.

If the carrier hardly falls through the orifice having a diameter of 2.5 mm, an orifice having a diameter of 5 mm can be used instead.

The volume resistivity in a logarithm scale (log (R)) of the carrier of the present invention measured in an electric field of 250 V/mm is preferably from 12 to 17, and more preferably from 12 to 14. When the volume resistivity is too low, a charge is induced in the carrier present in a developing section, resulting in occurrence of the carrier adhesion problem. This phenomenon occurs more frequently particularly when one or more of the following conditions are satisfied.

(1) the developing gap (i.e., a gap between the surface of an image bearing member and the surface of a developing sleeve) is narrow;

(2) the rotation speed of the image bearing member and/or the rotation speed of the developing sleeve are high; and

(3) an AC bias is applied to the developing section.

When color images are formed, a carrier having a low resistivity is typically used to adhere a sufficient amount of a color toner to an electrostatic image. By using the carrier of the present invention for a color developer, a color image having high image density can be produced.

When the volume resistivity (log (R)) of the carrier is too high, the carrier has a large amount of charge with a polarity opposite to that of the toner used, and thereby the carrier adhesion problem is easily caused.

The volume resistivity of a carrier can be determined by the method mentioned above for use in measuring the volume resistivity of a core material, which uses the cell illustrated in FIG. 1.

The volume resistivity of the carrier can be adjusted by adjusting the resistivity of the resin layer formed on the carrier and the thickness of the resin layer. In addition, it is possible to add an electroconductive material to the resin layer. Specific examples of the electroconductive material include electroconductive ZnO; metals such as Al and oxides of the metals; SnO₂ and SnO₂ doped with another element; boron compounds such as TiB₂, ZnB₂, and MoB₂; silicon carbide; electroconductive polymers such as polyacetylene, polyparaphenylene, poly(paraphenylenesulfide), polypyrrole, and polyethylene; carbon blacks such as furnace black, acetylene black and channel black; et.

Such electroconductive materials can be typically included in the resin layer by the following method. At first, an electroconductive material is mixed with a resin solution, and the mixture is subjected to a dispersion treatment using a dispersing machine such as dispersing machines using a medium (e.g., ball mills and bead mills), and agitators having rapidly spinning blades. The thus prepared coating liquid is coated on the surface of a core material.

Suitable resins for use in the resin layer on the carrier of the present invention include silicone resins having the following repeat units. 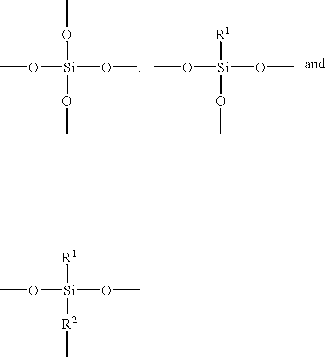
wherein R1 represents a hydrogen atom, a halogen atom, a hydroxyl group, a methoxy group, an alkyl group having from 1 to 4 carbon atoms, or an aryl group (such as phenyl and tolyl groups); R2 represents an alkylene group having from 1 to 4 carbon atoms or an arylene group (such as phenylene groups).

In the above-mentioned formulae, the aryl group has from 6 to 20 carbon atoms, and more preferably from 6 to 14 carbon atoms. Specific examples of the aryl groups include aryl groups (such as phenyl groups) derived from benzene; aryl groups derived from condensed polycyclic hydrocarbons (such as naphthalene and anthracene); and aryl groups derived from linear polycyclic hydrocarbons (such as biphenyl and terphenyl). The aryl groups can include one or more substituents.

In the above-mentioned formulae, the arylene group has from 6 to 20 carbon atoms, and more preferably from 6 to 14 carbon atoms. Specific examples of the arylene groups include arylene groups (such as phenylene groups) derived from benzene; arylene groups derived from condensed polycyclic hydrocarbons (such as naphthalene and anthracene); and arylene groups derived from linear polycyclic hydrocarbons (such as biphenyl and terphenyl). The arylene groups can include one or more substituents.

Suitable silicone resins for use in the resin layer on the carrier of the present invention include strait silicone resins. Specific examples of such straight silicone resins include KR-271, KR-272, KR-282, KR-252, KR-255, KR-152 (which are manufactured by Shin-Etsu Chemical Co., Ltd.), SR2400 and SR2406 (which are manufactured by Dow Corning Toray Silicone Co., Ltd.).

In addition, modified silicone resins can also be used for the resin layer. Specific examples of the modified silicone resins include epoxy-modified silicone resins, which are modified by an epoxy resin, an acrylic resin, a phenolic resin, a urethane resin, a polyester resin, and/or an alkyd resin.

Specific examples of the marketed modified silicone resins include ES-1001N (modified by an epoxy resin), KR-5208 (modified by an acrylic resin), KR-5203 (modified by a polyester resin), KR-206 (modified by an alkyd resin), KR-206 (modified by a urethane resin), which are manufactured by Shin-Etsu Chemical Co., Ltd., SR2115 (modified by an epoxy resin) and SR2110 (modified by an alkyd resin), which are manufactured by Dow Corning Toray Silicone Co., Ltd.

Further, other resins can be used alone or in combination with one or more of the above-mentioned silicone resins. Specific examples of such resins include styrene resins such as polystyrene, chloropolystyrene, poly-α-methylstyrene, styrene-chlorostyrene copolymers, styrene-propylene copolymers, styrene-vinyl chloride copolymers, styrene-vinyl acetate copolymers, styrene-maleic acid copolymers, styrene-acrylate copolymers (e.g., styrene-methyl acrylate copolymers, styrene-ethyl acrylate copolymers, styrene-butyl acrylate copolymers, styrene-octyl acrylate copolymers, and styrene-phenyl acrylate copolymers), styrene-methacrylate copolymers (e.g., styrene-methyl methacrylate copolymers, styrene-ethyl methacrylate copolymers, styrene-butyl methacrylate copolymers, and styrene-phenyl methacrylate copolymers), styrene-methyl α-chloroacrylate, and styrene-acrylonitrile-acrylate copolymers; epoxy resins, polyester resins, polyethylene resins, polypropylene resins, ionomer resins, polyurethane resins, ketone resins, ethylene-ethyl acrylate copolymers, xylene resins, polyamide resins, phenolic resins, polycarbonate resins, melamine resins, fluorine-containing resins, etc.

The resin layer can be formed by a coating method such as spray drying methods, dipping methods, and powder coating methods. By using a fluidized bed type coating device, a resin layer having a significantly uniform thickness can be formed. The thickness of the resin layer is generally from 0.02 to 1 μm, and preferably from 0.3 to 0.8 μm. Since the resin layer is very thin, the particle diameter of the coated carrier is almost the same as that of the core material.

By coating a silicone resin layer coating liquid including an aminosilane coupling agent on the carrier, the resultant carrier has good durability.

Specific examples of the aminosilane coupling agent include the following compounds:

H₂N(CH₂)₃Si(OCH₃)₃ (Mw of 179.3)

H₂N(CH₂)₃Si(OC₂H₅)₃ (Mw of 221.4)

H₂NCH₂CH₂CH₂Si(CH₃)₂ (OC₂H₅) (Mw of 161.3)

H₂NCH₂CH₂CH₂Si(CH₃)(OC₂H₅)₂ (Mw of 191.3)

H₂NCH₂CH₂NHCH₂Si(OCH₃)₃ (Mw of 194.3)

H₂NCH₂CH₂NHCH₂CH₂CH₂Si(CH₃)(OCH₃)₂ (Mw of 206.4)

H₂NCH₂CH₂NHCH₂CH₂CH₂Si(OCH₃)₃ (Mw of 224.4)

(CH₃)₂NCH₂CH₂CH₂Si(CH₃)(OC₂H₅)₂ (Mw of 219.4)

(C₄H₉)₂NC₃H₆Si(OCH₃)₃ (Mw of 291.6)

In order to reinforce the resin layer on the carrier of the present invention, one or more hard particulate material can be included in the resin layer. Among these hard particulate materials for use as the reinforcing material, particulate metal oxides and inorganic oxides are preferably used because of having significantly uniform particle diameters and high affinity for the resin components in the resin layer. By using such a reinforcing material, the resultant carrier has good durability. Specific examples of the particulate metal oxides include silicon-based oxides, titanium-based oxides and aluminum-based oxides.

The content of such a reinforcing material in the resin layer is preferably from 5 to 70% by weight, and more preferably from 2 to 40% by weight. The content of a reinforcing material in the resin layer is determined depending on the particle diameter and specific surface area of the reinforcing material. When the content is too low, the abrasion resistance cannot be well developed. In contrast, when the content is too high, the particles in the resin layer are easily released therefrom when the carrier is repeatedly used.

The developer of the present invention includes the carrier mentioned above and a toner.

Known toners such as toners in which toner constituents such as a colorant, a particulate material, a charge controlling agent, and a release agent are included in a binder resin can be used for the developer of the present invention. The method for manufacturing the toner is not particularly limited, and any known methods such as kneading/pulverization methods, polymerization methods, granulation methods can be used. In addition, the particle form of the toner is not particularly limited, and any known toners such as toners with irregular form or spherical toners can also be used. Further, both magnetic toners and nonmagnetic toners can be used.

Specific examples of the resins for use as the binder resin of the toner include styrene polymers and substituted styrene polymers such as polystyrene and polyvinyl toluene; styrene copolymers such as styrene-p-chlorostyrene copolymers, styrene-propylene copolymers, styrene-vinyl toluene copolymers, styrene-methyl acrylate copolymers, styrene-ethyl acrylate copolymers, styrene-butyl acrylate copolymers, styrene-methyl methacrylate copolymers, styrene-ethyl methacrylate copolymers, styrene-butyl methacrylate copolymers, styrene-methyl α-chloromethacrylate copolymers, styrene-acrylonitrile copolymers, styrene-vinyl methyl ether copolymers, styrene-vinyl methyl ketone copolymers, styrene-butadiene copolymers, styrene-isoprene copolymers, styrene-maleic acid copolymers and styrene-maleic acid ester copolymers; acrylic resins such as polymethyl methacrylate, and polybutyl methacrylate; and other resins such as polyvinyl chloride, polyvinyl acetate, polyethylene, polypropylene, polyesters, polyurethane resins, epoxy resins, polyvinyl butyral resins, polyacrylic acid resins, rosin, modified rosins, terpene resins, phenolic resins, aliphatic or alicyclic hydrocarbon resins, aromatic petroleum resins, chlorinated paraffin, paraffin waxes, etc. These resins are used alone or in combination.

By using a polyester resin as a binder resin, the resultant toner has relatively good preservation stability and low melt viscosity compared to those of toners including a styrene resin or an acrylic resin as a binder resin.

Such polyester resins can be prepared by subjecting an alcohol and an acid to a polycondensation reaction.

Suitable alcohol components include diols and polyols. Specific examples of diols include diols such as polyethylene glycol, diethylene glycol, triethylene glycol, 1,2-propylene glycol, 1,3-propylene glycol, 1,4-butanediol, neopentyl glycol, 1,4-butenediol, 1,5-pentanediol and 1,6-hexanediol; bisphenols and derivatives thereof such as 1,4-bis(hydroxymethyl)cyclohexane, bisphenol A, hydrogenated bisphenol A, etherified bisphenol A such as polyoxyethylenated bisphenol A and polyoxypropylenated bisphenol A. Those diols can be substituted with a saturated or unsaturated hydrocarbon group having from 3 to 22 carbon atoms.

Specific examples of the polyhydric alcohols having three or more hydroxyl groups include sorbitol, 1,2,3,6-hexanetetrol, 1,4-sorbitane, pentaerythritol, dipentaerythritol, tripentaerythritol, sucrose, 1,2,4-butanetriol, 1,2,5-pentanetriol, glycerol, 2-methylpropanetriol, 2-metyl-1,2,4-butanetriol, trimethylol ethane, trimethylol propane, 1,3,5-trihydroxymethyl benzene, etc.

Suitable acid components include monocarboxylic acids, dibasic or polybasic acids having three or more carboxyl groups.

Specific examples of the monocarboxylic acids include palmitic acid, stearic acid, and oleic acid. Specific examples of the dibasic acids include dibasic organic acids such as maleic acid, fumaric acid, mesaconic acid, citraconic acid, terephthalic acid, cyclohexane dicarboxylic acid, succinic acid, adipic acid, sebacic acid, and malonic acid; substituted dibasic organic acids in which the above-mentioned dibasic organic acids are substituted with a saturated or unsaturated hydrocarbon group having from 3 to 22 carbon atoms; dimmer acids of an anhydride or a lower alkyl ester of the above-mentioned dibasic organic acids with linolenic acid; 1,2,4-benzene tricarboxylic acid, 1,2,5-benzene tricarboxylic acid, 2,5,7-naphthalene tricarboxylic acid, 1,2,4-naphthalene tricarboxylic acid, 1,2,4-butane tricarboxyic acid, 1,2,5-hexane tricarboxyic acid, 1,3-dicarboxyl-2-methyl-2-carboxymethyl propane, tetra(methylenecarboxyl)methane, and 1,2,7,8-octane tetracarboxylic acid; anhydrides of these acids; etc.

Specific examples of the epoxy resins include polycondensation products of bisphenol A and epichlorohydrin, etc. Specific examples of the marketed epoxy resins include EPOMIC R362, R364, R365, R366, R367, and R369 (which are manufactured by Mitsui Petrochemical Industries, Ltd.), EPOTOHTO YD-011, YD-012, YD-014, YD-904, and YD-017 (which are manufactured by Tohto Kasei Co., Ltd.), and EPOCOAT 1002, 1004 and 1007 (which are manufactured by Shell).

Specific examples of the colorant includes known dyes and pigments such as carbon blacks, lamp blacks, iron blacks, ultramarine blue, Nigrosine dyes, Aniline Blue, Phthalocyanine Blue, Phthalocyanine Green, HANSA YELLOW G, Rhodamine 6C Lake, chalco-oil blue, Chrome Yellow, quinacridone, BENZIDINE YELLOW, Rose Bengale, triarylmethane dyes, monoazo pigments, disazo pigments, etc. These colorants can be used alone or in combination.

A magnetic material can be included in the toner to prepare a magnetic-toner. Specific examples of the magnetic materials include ferromagnetic materials such as iron and cobalt, magnetite, hematite, ferrites such as Li ferrite, Mn—Zn ferrite, Cu—Zn ferrite, Ni—Zn ferrite, Ba ferrite, etc.

A charge controlling agent can be included in the toner for use in the developer of the present invention can include to control the friction-charging properties of the toner. Specific examples of the charge controlling agents include metal complexes of monoazo dyes, nitrohumic acid and its salts, metal (such as Co, Cr and Fe) complexes of salicylic acid, naphthoic acid and dicarboxylic acid, amino compounds, quaternary ammonium compounds, organic dyes, etc.

A release agent can be included in the toner. Specific examples of the release agents include low molecular weight polyethylene, low molecular weight polypropylene, carnauba waxes, microcrystalline waxes, jojoba waxes, rice waxes, montan waxes, etc. These release agents can be used alone or in combination.

An external additive can be added to the toner to improve the fluidity, releasability or other properties of the toner. Suitable fluidity improving agents include hydrophobized metal oxides such as silica and titanium oxide. Among these fluidity improving agents, hydrophobized silica is preferably used. Suitable lubricants include particulate resins such as fluorine-containing resins (such as polytetrafluoro ethylene) and metal soaps such as zinc stearate; etc. In addition; abrasives such as cerium oxide and silicon carbide; caking preventing agents, etc. can also be added to the toner.

The toner for use in the developer of the present invention has a weight average particle diameter (Dt) of from 3.0 to 9.0 μm, and preferably from 3.5 to 7.5 μm. The ratio (T/C) of the toner (T) to the carrier (C) in the developer of the present invention is from 2/100 to 25/100, and preferably from 3/100 to 20/100.

In the present application, the particle diameter of the toner is measured using an instrument, COULTER COUNTER (manufactured by Beckman Coulter).

Then the image forming method of the present invention, which produce images using the developer of the present invention, will be explained referring to drawings.

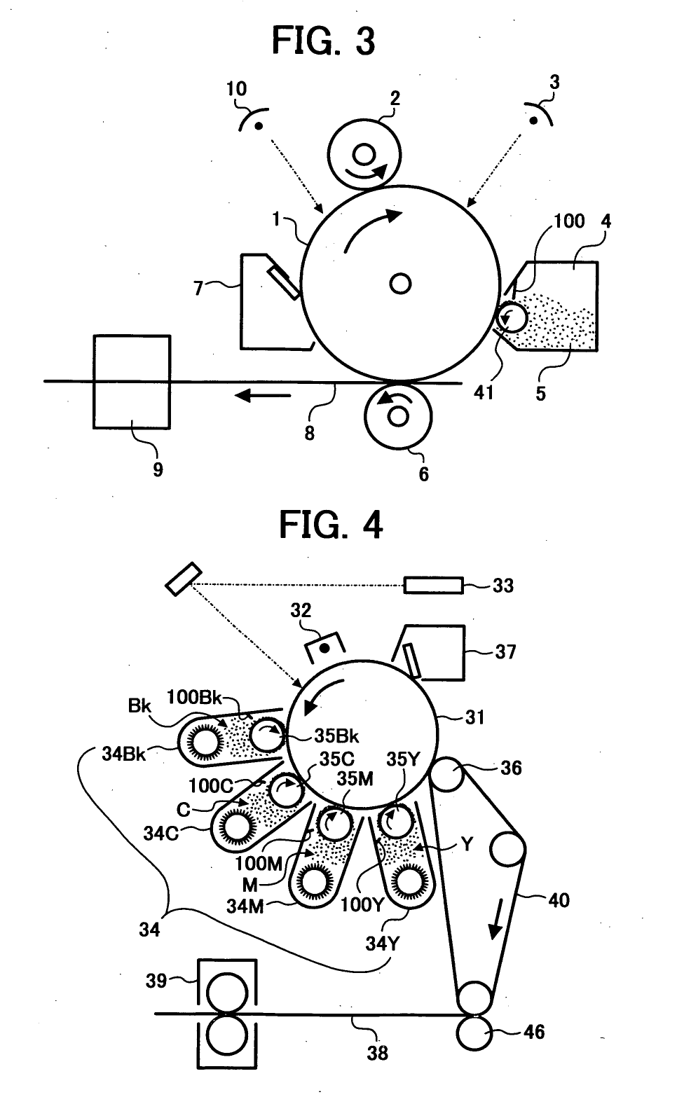

FIG. 3 is a schematic view illustrating an electrophotographic image forming apparatus for use in the image forming method of the present invention. The below-mentioned modified versions can also be included in the scope of the present invention.

In FIG. 3, numeral 1 denotes a photoreceptor serving as an image bearing member.

The photoreceptor 1 has a drum form, but photoreceptors having a form such as sheet-form and endless belt-form can also be used.

Around the photoreceptor 1, a quenching lamp 10 configured to decrease charges remaining on the photoreceptor 1, a charger 2 configured to charge the photoreceptor 1, an imagewise light irradiator 3 configured to irradiate the photoreceptor 1 with imagewise light to form an electrostatic latent image on the photoreceptor 1, a developing device 4 configured to develop the latent image with a developer 5, which is the developer of the present invention, to form a toner image on the photoreceptor 1, and a cleaning unit 7 including a cleaning blade configured to clean the surface of the photoreceptor 1 are arranged while contacting or being set closely to the photoreceptor 1. The toner image formed on the photoreceptor 1 is transferred on a receiving paper 8 by a transfer device 6. The toner image on the receiving paper 8 is fixed thereon by a fixer 9.

The developing device 4 includes a developing roller 41 serving as a developer bearing member and a developing blade 100 configured to form a uniform thin developer layer on the surface of the developing roller 41. The electrostatic latent image formed on the photoreceptor 1 is developed with the toner in the developer layer formed on the surface of the developing roller 41.

As the charger 2, any known chargers such as corotrons, scorotrons, solid state chargers, and roller chargers can be used. Among the chargers, contact chargers and short-range chargers which charge a photoreceptor while a small gap is formed between the surface of the charging member thereof and the surface of the photoreceptor are preferably used because of consuming low power.

As the transfer device 6, the above-mentioned known chargers can be used. Among the chargers, a combination of a transfer charger and a separating charger is preferably used.

Suitable light sources for use in the imagewise light irradiator 3 and the quenching lamp 10 include fluorescent lamps, tungsten lamps, halogen lamps, mercury lamps, sodium lamps, light emitting diodes (LEDs), laser diodes (LDs), light sources using electroluminescence (EL), and the like. In addition, in order to obtain light having a desired wave length range, filters such as sharp-cut filters, band pass filters, near-infrared cutting filters, dichroic filters, interference filters, color temperature converting filters and the like can be used.

When the toner image formed on the photoreceptor 1 by the developing device 4 is transferred onto the receiving paper 8, all of the toner image are not transferred on the receiving paper 8, and toner particles remain on the surface of the photoreceptor 1. The residual toner is removed from the photoreceptor 1 by the cleaner 7. Suitable cleaners for use as the cleaner 7 include cleaning blades made of a rubber, fur blushes and mag-fur blushes.

When the photoreceptor 1 which is previously charged positively (or negatively) with the charger 2 is exposed to imagewise light, an electrostatic latent image having a positive (or negative) charge is formed on the photoreceptor 1. When the latent image having a positive (or negative) charge is developed with a toner having a negative (or positive) charge, a positive image can be obtained. In contrast, when the latent image having a positive (negative) charge is developed with a toner having a positive (negative) charge, a negative image (i.e., a reversal image) can be obtained.

FIG. 4 illustrates another image forming apparatus for use in the image forming method of the present invention, which can produce full color images. Referring to FIG. 4, the image forming apparatus has a photoreceptor 31 serving as an image bearing member. Around the photoreceptor 31, a charger 32, an imagewise light irradiator 33, an image developing unit 34 having a black developing device 34Bk, a cyan developing device 34C, a magenta developing device 34M and a yellow developing device 34Y, an intermediate transfer belt 40 serving as an intermediate transfer medium, and a cleaner 37 are arranged.

The developing devices 34Bk, 34C, 34M and 34Y can be independently controlled, and each of the developing devices is independently driven when desired. In each of the developing device, an electrostatic latent image formed on the photoreceptor 31 is developed with a developer layer formed on a developing roller 35Bk, 35C, 35M or 35Y by a developing blade 100Bk, 100C, 100M or 100Y, respectively. Characters Bk, C, M and Y denote black, cyan, magenta and yellow colors, respectively. The color toner images thus formed on the photoreceptor 31 are transferred onto the intermediate transfer belt 40 by a first transfer device 36. In this case, it is preferable to apply a voltage to the first transfer device 36 to place the toner image in an electric field. The intermediate transfer belt 40 is brought into contact with the photoreceptor 31 by the first transfer device 36 only when a toner image on the photoreceptor 31 is transferred thereto. The toner images overlaid on the intermediate transfer belt 40 are transferred onto a receiving material 38 by a second transfer device 46, and the full color toner images are fixed on the receiving material 38 by a fixer 39. The second transfer device 46 is brought into contact with the intermediate transfer belt 40 only when the transfer operation is performed.

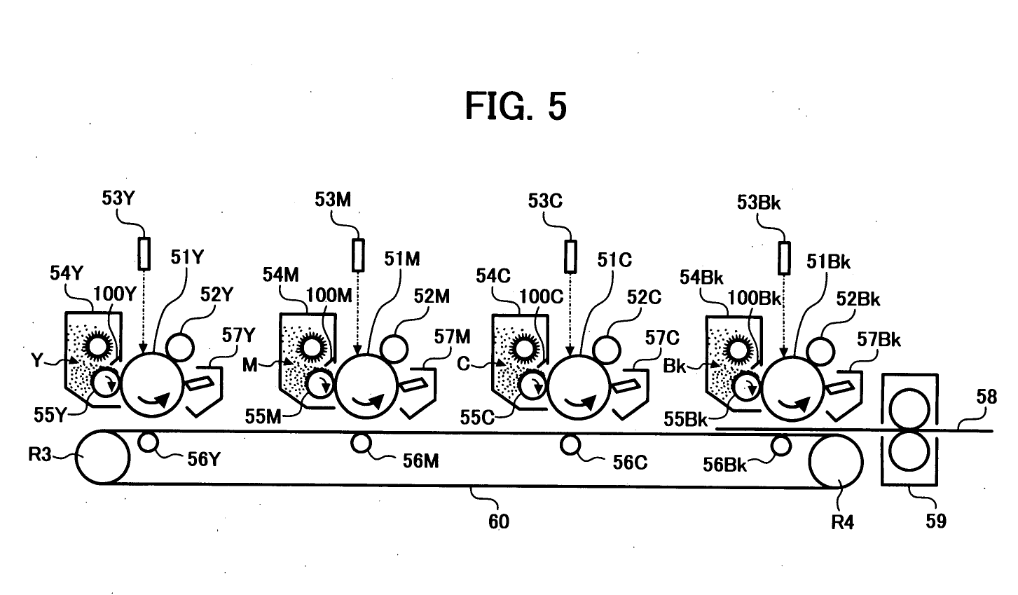

In an image forming apparatus having a drum-form transfer device, color toner images are transferred onto a receiving material electrostatically attached to the transfer drum. Therefore, an image cannot be formed on a thick paper. However, in the image forming apparatus as illustrated in FIG. 4, each toner image is formed on the intermediate transfer belt and the overlaid toner images are transferred onto a receiving material while applying a pressure thereto. Therefore, an image can be formed on any kinds of receiving materials. The image forming method using an intermediate transfer medium can also be applied to the image forming apparatus as illustrated in FIG. 5.

FIG. 5 illustrates yet another image forming apparatus for use in the image forming method of the present invention.

The image forming apparatus has four color image forming sections, i.e., yellow, magenta, cyan and black image forming sections. The image forming sections include respective photoreceptors 51Y, 51M, 51C and 51Bk.

Around each of the photoreceptors 51Y, 51M, 51C and 51Bk, a charger (52Y, 52M, 52C or 52Bk), an imagewise light irradiator (53Y, 53M, 53C or 53Bk), a developing device (54Y, 54M, 54C or 54Bk), and a cleaner (57Y, 57M, 57C or 57Bk) are arranged. Each developing device (54Y, 54M, 54C or 54Bk) includes a developing roller (55Y, 55M, 55C or 55Bk) and a developing blade (100Y, 100M, 100C or 100Bk). In addition, a feed/transfer belt 60, which is arranged below the image forming sections, is tightly stretched by rollers R3 and R4. The feed/transfer belt 60 is attached to or detached from the photoreceptors by transfer devices 56Y, 56M, 56C and 56Bk to transfer toner images from the photoreceptors to a receiving material 58. The resultant color toner image is fixed by a fixer 59.

The tandem-type image forming apparatus illustrated in FIG. 5 has four photoreceptors for forming four color images, and color toner images which are formed in parallel are transferred onto the receiving material 58. Therefore, the image forming apparatus can form full color images at a high speed.

Each developing device (54Y, 54M, 54C or 54Bk) also includes a developer (Y, M, C or Bk).

The above-mentioned image forming unit may be fixedly set in a copier, a facsimile or a printer. However, the image forming unit may be set therein as a process cartridge.

The process cartridge of the present invention includes at least an image bearing member configured to bear an electrostatic image, and a developing device configured to develop the electrostatic image with the developer of the present invention to form a toner image on the image bearing member, wherein the image bearing member and the developing device are unitized. The process cartridge can optionally includes other devices such as a charger configured to charge the image bearing member, and a cleaner (such as blades and brushes) configured to clean the surface of the image bearing member to remove toner particle remaining on the image bearing member after the toner image is transferred onto a receiving material.

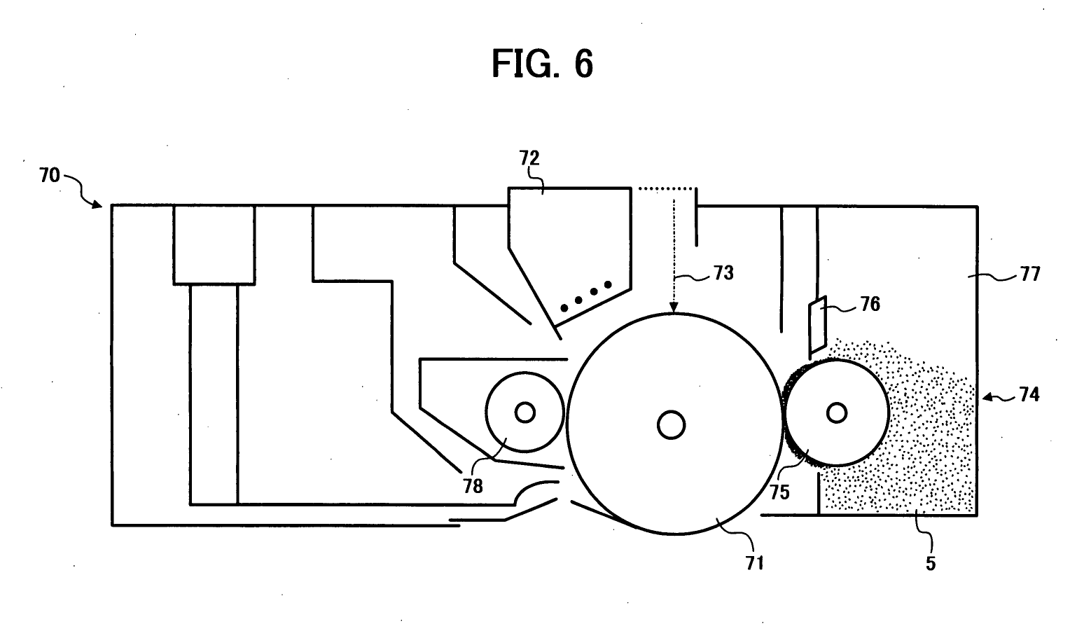

FIG. 6 is a schematic view illustrating an embodiment of the process cartridge of the present invention. In FIG. 6, a process cartridge 70 includes a photoreceptor 71 serving as an electrostatic latent image bearing member, a charger 72 configured to charge the photoreceptor 71, a developing device (a developing roller) 74 configured to develop the latent image with the developer 5, which is the developer of the present invention, and a cleaning brush 78 configured to clean the surface of the photoreceptor 71. Numeral 73 denotes an imagewise light beam configured to irradiate the photoreceptor 71 to form an electrostatic latent image on the photoreceptor 71.

The developing device 74 includes a developer container 77 configured to contain the developer 5 of the present invention, a developing roller 75 configured to develop the latent image on the surface of the photoreceptor 71 and a developer blade 76 configured to form a significantly uniform thin layer of the developer 5 on the developing roller 75.

The structure of the process cartridge of the present invention is not limited to that illustrated in FIG. 6.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### Carrier Preparation Example 1

A silicone resin solution (SR2411 from Dow Corning Toray Silicone Co., Ltd.), an electroconductive carbon black having a specific surface area of 1270 m²/g and a particulate alumina having an average particle diameter of 0.3 μm were mixed in a ratio (on a dry weight basis) of 100/5/5. The mixture was subjected to a dispersion treatment for 30 minutes using a HOMOGENIZER. After being diluted so as to have a solid content of 10% by weight, the dispersion was mixed with an aminosilane coupling agent (NH₂(CH₂)₃Si(OCH₃)) in a ratio (on a dry weight basis) of 100/3. Thus, a resin layer coating liquid 1 was prepared.

The resin layer coating liquid 1 was coated on the surface of a core material 1 having properties illustrated in Table 1 using a fluidized bed type coating machine under the following conditions:

Temperature of atmosphere: 100° C.

Processing speed: 50 g/min

The thus coated carrier was further heated for 2 hours at 250° C. Thus, a carrier A having thereon a resin layer with a thickness of 0.6 μm was prepared. The thickness of the resin layer was determined by cutting a carrier particle and observing the cross section with a scanning electron microscope.

### Carrier Manufacturing Examples 2-7

The procedure for preparation of the carrier A in Carrier Preparation Example 1 was repeated except that the core material 1 was replaced with each of the core materials 2-7 having properties illustrated in Table 1.

Thus, carriers B-H were prepared.

### Carrier Manufacturing Example 8

The procedure for preparation of the carrier A in Carrier Preparation Example 1 was repeated except that the added amount of the electroconductive carbon black was changed from 5% to 7.5% by weight.

Thus, a carrier I was prepared.

The core materials 1-5, 7 and 8 are Cu—Zn ferrites, and the core material 6 is a Mn—Mg—Sr ferrite. The properties of the core materials 1-8 are illustrated in Tables 1-1 and 1-2.

TABLE 1-1

| | Core | Dw | | C_{<20} | C_{<36} |
|---|---|---|---|---|---|
| Carrier | material | (μm) | Dw/Dp | (%) | (%) |
| A | 1 | 28.2 | 1.14 | 6.2 | 90.7 |
| B | 2 | 28.1 | 1.13 | 6.3 | 90.5 |
| C | 3 | 28.4 | 1.12 | 6.1 | 91.1 |
| D | 4 | 28.2 | 1.13 | 5.9 | 91.3 |
| E | 5 | 29.6 | 1.12 | 3.5 | 91.2 |
| F | 6 | 28.8 | 1.11 | 6.8 | 93.8 |
| G | 7 | 28.1 | 1.14 | 6.3 | 91.0 |
| H | 8 | 25.9 | 1.15 | 15.2 | 94.8 |
| I | 1 | 28.2 | 1.14 | 6.2 | 90.7 |

C_{<20}: Content of particles having a diameter of less than 20 μm

C_{<36}: Content of particles having a diameter of less than 36 μm

TABLE 1-2

| | | log R2/ | M | D_{B} | |
|---|---|---|---|---|---|
| Carrier | log R1 | log R3 | (emu/g) | (g/cm³) | log Rc |
| A | 8.9 | 0.88 | 58 | 2.18 | 15.2 |
| B | 9.4 | 0.95 | 58 | 2.20 | 15.3 |
| C | 7.8 | 0.88 | 58 | 2.17 | 15.2 |
| D | 8.8 | 0.65 | 58 | 2.19 | 15.3 |
| E | 8.9 | 0.88 | 58 | 2.20 | 15.2 |
| F | 8.7 | 0.91 | 72 | 2.32 | 15.2 |
| G | 8.6 | 0.94 | 58 | 2.46 | 15.1 |
| H | 9.4 | 0.95 | 58 | 2.25 | 15.3 |
| I | 8.9 | 0.88 | 58 | 2.18 | 15.5 |

M: Magnetic moment of core material
D_{B}: Bulk density
log Rc: volume resistivity of carrier in logarithm scale

Preparation of Toner

The following components were mixed using a blender.

| | | |
|---|---|---|
| Polyester resin | 100 | parts |
| Quinacridone magenta pigment | 3.5 | parts |
| Fluorine-containing quaternary ammonium salt | 4 | parts |

Then the mixture was melted and kneaded using a double-axis extruder, followed by cooling and crushing using a cutter mill. The crushed material was pulverized with a jet air pulverizer, followed by classification using an air classifier. Thus, a mother toner having a weight average particle diameter of 6.8 μm and a specific gravity of 1.20 was prepared.

Then 0.8 parts of a hydrophobized silica (R972 from Nippon Aerosil Co.) was mixed with 100 parts of the mother toner, and the mixture was mixed with a HENSCHEL mixer. Thus a toner was prepared.

### Example 1

Preparation of Developer

One hundred (100) parts of the carrier A was mixed with 13.1 parts of the toner prepared above, and the mixture was agitated for 20 minutes using a ball mill to prepare a developer. The content of the toner is 11.6% by weight and the toner coverage at which the surface of the carrier is covered with the toner is 50%. The toner coverage (C) is determined by the following equation.
C (%)=(Wt/Wc)×(ρc/ρt)×(Dw/Dt)×(¼)×100
wherein Wt and Wc represent the weights of the toner and carrier, respectively; ρc and ρt represent the true densities of the toner and carrier, respectively; and Dw and Dt represent the weight average particle diameters (μm) of the toner and carrier, respectively.

Thus, a developer was prepared.

Evaluation Method

The developer was set in a digital color copier and printer IMAGIO COLOR 5000 from Ricoh Co., Ltd. Images were produced under the following conditions.

Development gap: 0.4 mm

(gap between surface of photoreceptor and surface of developing sleeve)

Doctor gap: 0.7 mm

(gap between surface of developing sleeve and tip of doctor blade)

Linear speed of photoreceptor (Vp): 245 mm/sec

Linear speed of development sleeve (Vs): 367.5 mm/sec

Vp/Vs: 1.5

Image writing density: 600 dpi

Potential of non-lighted portion: −750 V

Potential of lighted portion: −100 V

Development bias: DC/AC
DC voltage: −500 V
AC voltage: −100 to −900 V
   2 KHz (frequency)
   50% (duty)

The evaluation items and evaluation methods are as follows.

(1) Image Density (ID)

The image density of the center of a solid image in the image with a size of 30 mm×30 mm was measured with a densitometer X-RITE 938 from X-Rite. The image density operation was repeated 5 times to average the data.

(2) Granularity (G)

The granularity of the image, which is defined by the following equation was measured.
G=exp(aL+b)∫(WS(f))^{1/2}·VTF(f)df
wherein L represents the brightness of the image; f represents the spatial frequency (cycle/mm); WS(f) represents the power spectrum of variation of the brightness; VTF(f) represents the visual spatial frequency characteristic; and each of a and b is a constant.

The granularity is classified into the following four grades:

⊚: granularity is less than 0.1 (excellent)

◯: granularity is not less than 0.1 and less than 0.2 (good)

Δ: granularity is not less than 0.2 and less than 0.3 (acceptable)

X: granularity is not less than 0.3 (bad)

(3) Background Development (GD)

The background area of the images is visually observed whether the background area is soiled with toner particles. The background development is classified into the following three grades.

⊚: excellent

◯: good

X: bad (unacceptable)

(4) Carrier Adhesion (CA)

An electrostatic image having a potential of −750 V (i.e., potential of a background portion), which is formed on the photoreceptor, is developed with the developer while a development DC bias of −400 V is applied thereto. An adhesive tape is attached to a portion of the photoreceptor having an area of 30 cm² and then detached therefrom to count the number of carrier particles present on the portion of the photoreceptor.

(5) Carrier Adhesion after Running Test (CA-2)

After a running test in which 20,000 copies of a character image with an image area proportion of 6% are produced while a fresh toner is replenished to the image forming apparatus, the evaluation of the carrier adhesion test described above was performed on the developer.

### Examples 2 to 5

The procedure for preparation and evaluation of the developer in Example 1 was repeated except that the carrier A was changed to each of the carriers B-I.

The evaluation results are shown in Table 2.

TABLE 2

| | Carrier | ID | G | GD | CA | CA-2 |
|---|---|---|---|---|---|---|
| Ex. 1 | A | ◯ | ◯ | ◯ | ◯ | ◯ |
| Ex. 2 | B | ◯ | ◯ | ◯ | ⊚ | ⊚ |
| Ex. 3 | E | ◯ | ◯ | ◯ | ⊚ | ⊚ |
| Ex. 4 | F | ◯ | ◯ | ◯ | ⊚ | ⊚ |
| Ex. 5 | G | ◯ | ◯ | ◯ | ⊚ | ⊚ |
| Ex. 6 | I | ⊚ | ⊚ | ⊚ | ⊚ | ⊚ |
| Comp. | C | ◯ | ◯ | ◯ | ◯ | X |
| Ex. 1 | | | | | | |
| Comp. | D | ◯ | ◯ | ◯ | ◯ | X |
| Ex. 2 | | | | | | |
| Comp. | H | ◯ | ◯ | X | X | X |
| Ex. 3 | | | | | | |

It is clear from Table 2 that the developer (carrier) of the present invention can produce high quality images without causing the carrier adhesion problem. Particularly, the developer of Example 6 can produce images having excellent image qualities without causing the carrier adhesion problem.

In contrast, the carrier C which has a log (R1) of 7.8, which is lower than the preferable range of from 8.0 to 10.5, and the carrier D which has a log (R2)/log (R3) ratio of 0.65, which is lower than the preferable range of from 0.85 to 1.0, cause the carrier adhesion problem after long repeated use. In addition, the carrier H including carrier particles having a particle diameter less than 20 μm in an amount of 15.2% by weight, which is higher than the preferable range of from 0 to 7% by weight, always causes the carrier adhesion problem and the background development problem.

This document claims priority and contains subject matter related to Japanese Patent Applications Nos. 2005-203853 and 2005-075962, filed on Jul. 13, 2005, and Mar. 16, 2005, respectively, incorporated herein by reference.

Having now fully described the invention, it will be apparent to one of ordinary skill in the art that many changes and modifications can be made thereto without departing from the spirit and scope of the invention as set forth therein.

What is claimed as new and desired to be secured by Letters Patent of the United States is:

1. A carrier comprising:
a magnetic core material; and
a layer located on the surface of the core material and including a resin,
wherein the carrier satisfies the following relationships (1)-(6):
(1) 22 μm≦Dw≦32 μm, wherein Dw represents a weight average particle diameter of the carrier;
(2) 1.0<Dw/Dp<1.2, wherein Dp represents a number average particle diameter of the carrier;
(3) 0% by weight≦C_{<20}≦7% by weight, wherein C_{<20} represents a content of carrier particles having a particle diameter of less than 20 μm in the carrier;
(4) 90% by weight≦C_{<36}≦100% by weight, wherein C_{<36} represents a content of carrier particles having a particle diameter of less than 36 μm in the carrier;
(5) 8.0≦log (R1)≦10.5, wherein R1 represents a volume resistivity in units of Ω·cm of the core material, which is determined in an electric field of 50 V/mm; and
(6) 0.85≦log (R2)/log (R3)≦1.0, wherein R2 represents a volume resistivity in units of Ω·cm of chains of particles of the core material, which is determined in an electric field of 250 V/mm, and R3 represents a volume resistivity in units of Ω·cm of chains of particles of the core material, which is determined in an electric field of 50 V/mm, wherein the chains of particles of the core material are formed using a magnetic pole with 1500 gauss.

2. The carrier according to claim 1, wherein the content C_{<20} of the carrier particles having a particle diameter of less than 20 μm in the carrier is from 0% to 5% by weight.

3. The carrier according to claim 1, wherein the magnetic core material has a magnetic moment of from 70 to 150 emu/g in a magnetic field of 1000 Oe.

4. The carrier according to claim 1, wherein the magnetic core material has a bulk density of from 2.35 to 2.5 g/cm³.

5. The carrier according to claim 1, wherein the carrier further satisfies the following relationship:
12≦log (Rc)≦14,
wherein Rc represents a volume resistivity in units of Ω·cm of the carrier, which is determined in an electric field of 250 V/mm.

6. The carrier according to claim 1, wherein the layer comprises a silicone resin.

7. The carrier according to claim 1, wherein the layer comprises a particulate material.

8. The carrier according to claim 7, wherein the particulate material is a metal oxide selected from the group consisting of Si-containing oxides, Ti-containing oxides, and Al-containing oxides.

9. A developer comprising:
a toner; and
the carrier according to claim 1.

10. An image forming method comprising:
developing an electrostatic image on an image bearing member with the developer according to claim 9 to form a toner image on the image bearing member;
transferring the toner image to a receiving material; and
cleaning a surface of the image bearing member after the toner image is transferred.

11. A process cartridge comprising:
an image bearing member configured to bear an electrostatic image thereon; and
a developing device configured to develop the electrostatic image with the developer according to claim 9 to form a toner image on the image bearing member,
wherein the image bearing member and the developing device are unitized in the process cartridge.
